(19) United States
(12) Patent Application Publication
(10) Pub. No.: US 2008/0171179 A1
(43) Pub. Date: Jul. 17, 2008

(54) Low embodied energy wallboards and methods of making same

(75) Inventors: Kevin J. Surace, Sunnyvale, CA (US); Meredith Ware, East Palo Alto, CA (US); Marc U. Porat, Palo Alto, CA (US)

Correspondence Address: MACPHERSON KWOK CHEN & HEID LLP, 2033 GATEWAY PLACE, SUITE 400, SAN JOSE, CA, 95110, US

(73) Assignee: Quiet Solution, LLC

(21) Appl. No.: 11/652,991

(22) Filed: Jan. 11, 2007

(51) Int. Cl. B32B 3/00; C04B 12/02

(52) U.S. Cl. 428/172; 106/459; 106/691; 428/220

(57) ABSTRACT

Wallboards are produced by methods which use significantly reduced Embodied Energy when compared with the energy used to fabricate gypsum wallboard. A novel binder, consisting in one embodiment of monopotassium phosphate and magnesium oxide, and combined with various fillers, is used to provide a controlled exothermic reaction to create a gypsum board-like core which can be wrapped in a selected material such as recycled paper and manufactured on a conveyor system to appear and handle like gypsum wallboard, but without the large energy required to make gypsum wallboard. The resultant product may be used in interior or exterior applications and possesses the fire, sound and other important properties of gypsum wallboard. As energy costs increase, the novel wallboards of this invention can become less expensive to manufacture than traditional wallboard. The manufacturing process results in much lower greenhouse gas emissions than the processes used to make gypsum wallboard.

### FIELD OF INVENTION

The present invention relates to new compositions of wallboard cores and the processes for fabricating such cores and in particular to cores and processes which reduce the energy required to manufacture the wallboards when compared to the energy required to manufacture traditional gypsum wallboard.

### BACKGROUND OF THE INVENTION

Gypsum wallboard is used in the construction of residential and commercial buildings to form interior walls and ceilings and also exterior walls in certain situations. Because it is relatively easy to install and requires minimal finishing, gypsum wallboard is the preferred material to be used for this purpose in constructing homes and offices.

Gypsum wallboard consists of a hardened gypsum-containing core surfaced with paper or other fibrous material suitable for receiving a coating such as paint. It is common to manufacture gypsum wallboard by placing an aqueous core slurry comprised predominantly of calcined gypsum between two sheets of paper thereby forming a sandwich structure. Various types of cover paper are known in the art. The aqueous gypsum core slurry is allowed to set or harden by rehydration of the calcined gypsum, usually followed by heat treatment in a dryer to remove excess water. After the gypsum slurry has set (i.e., reacted with water present in the aqueous slurry) and dried, the formed sheet is cut into required sizes. Methods for the production of gypsum wallboard are well known in the art.

A conventional process for manufacturing the core composition of gypsum wallboard initially includes the premixing of dry ingredients in a high-speed mixing apparatus. The dry ingredients often include calcium sulfate hemihydrate (stucco), an accelerator, and an antidesiccant (e.g., starch). The dry ingredients are mixed together with a “wet” (aqueous) portion of the core composition in a mixer apparatus. The wet portion can include a first component that includes a mixture of water, paper pulp, and, optionally, one or more fluidity-increasing agents, and a set retarder. The paper pulp solution provides a major portion of the water that forms the gypsum slurry of the core composition. A second wet component can include a mixture of the aforementioned strengthening agent, foam, and other conventional additives, if desired. Together, the aforementioned dry and wet portions comprise an aqueous gypsum slurry that eventually forms a gypsum wallboard core.

A major ingredient of the gypsum wallboard core is calcium sulfate hemihydrate, commonly referred to as “calcined gypsum,” “stucco,” or “plaster of Paris.” Stucco has a number of desirable physical properties including, but not limited to, fire resistance, thermal and hydrometric dimensional stability, compressive strength, and neutral pH. Typically, stucco is prepared by drying, grinding, and calcining natural gypsum rock (i.e., calcium sulfate dihydrate). The drying step in the manufacture of stucco includes passing crude gypsum rock through a rotary kiln to remove any moisture present in the rock from rain or snow, for example. The dried rock then is ground to a desired fineness. The dried, fine-ground gypsum can be referred to as “land plaster” regardless of its intended use. The land plaster is used as feed to calcination processes for conversion to stucco.

The calcination (or dehydration) step in the manufacture of stucco is performed by heating the land plaster which yields calcium sulfate hemihydrate (stucco) and water vapor.

This calcination process step is performed in a “calciner,” of which there are several types known by those of skill in the art.

Calcined gypsum reacts directly with water and can “set” when mixed with water in the proper ratios. However, the calcining process itself is energy intensive. Several methods have been described for calcining gypsum using single and multi staged apparatus, such as that described in U.S. Pat. No. 5,954,497.

Conventionally in the manufacture of gypsum board, the gypsum slurry, which may consist of several additives to reduce weight and add other properties, is deposited upon a moving paper (or fiberglass matt) substrate, which, itself, is supported on a long moving belt. A second paper substrate is then applied on top of the slurry to constitute the second face of the gypsum board and the sandwich is passed through a forming station, which determines the width and thickness of the gypsum board. In such a continuous operation the gypsum slurry begins to set after passing through the forming station. When sufficient setting has occurred the board is cut into commercially acceptable lengths and then passed into a board dryer. Thereafter the board is trimmed if desired, taped, bundled, shipped, and stored prior to sale.

The majority of gypsum wallboard is sold in sheets that are four feet wide and eight feet long. The thicknesses of the sheets vary from one-quarter inch to one inch depending upon the particular grade and application, with a thickness of ½″ or ⅝″ being common. A variety of sheet sizes and thicknesses of gypsum wallboard are produced for various applications. Such boards are easy to use and can be easily scored and snapped to break them in relatively clean lines.

The process to manufacture gypsum wallboard is by some accounts over 100 years old. It was developed at a time when energy was plentiful and cheap, and greenhouse gas issues were unknown. This is an important attribute. While gypsum wallboard technology has improved over the years to include fire resistance as an attribute of certain wallboards, and gypsum wallboard testing has been standardized (such as in ASTM C1396), there has been little change in the major manufacturing steps, and the majority of wallboard is still made from calcined gypsum.

As shown in FIG. 1, which depicts the major steps in a typical process to manufacture gypsum wallboard, gypsum wallboard requires significant energy to produce. “Embodied Energy” is defined as “the total energy required to produce a product from the raw materials stage through delivery” of finished product. As shown in FIG. 1, four of the steps (drying gypsum, calcining gypsum, mixing the slurry with hot water and drying the boards) in the manufacture of gypsum wallboard take considerable energy. Thus the Embodied Energy of gypsum, and the resultant greenhouse gasses, are very high. However few other building materials exist today to replace gypsum wallboard.

Energy is used throughout the gypsum process. After the gypsum rock is pulled from the ground it must be dried, typically in a rotary or flash dryer. Then it must be crushed and then calcined (though crushing often comes before drying). All of these processes require significant energy just to prepare the gypsum for use in the manufacturing process. After it has been calcined, it is then mixed typically with hot water (often close to boiling temperature—requiring more energy) to form a hot slurry which begins to set, after which the boards (cut from the set slurry) are dried in large board driers for about 40 to 60 minutes to evaporate the residual water, using significant energy. Often up to one pound (1 lb) per square foot of water needs to be dried back out of the gypsum board prior to packing. Thus, it would be highly desirable to reduce the overall Embodied Energy of gypsum wallboard, thus reducing energy costs and greenhouse gasses.

Greenhouse gasses, particularly CO₂, are produced from the burning of fossil fuels and also as a result of calcining certain materials, such as gypsum. Thus the gypsum manufacturing process generates significant amounts of greenhouse gasses due to the requirements of the process.

According to the National Institute of Standards and Technology (NIST—US Department of Commerce), specifically NISTIR 6916, the manufacture of gypsum wallboard requires 8,196 BTU's per pound. With an average ⅝″ gypsum board weighing approximately 75 pounds, this equates to over 600,000 BTU's per board total Embodied Energy. Other sources suggest that Embodied Energy is less than 600,000 BTU's per board, while others suggest it may be even more. It has been estimated that Embodied Energy constitutes over 50% of the cost of manufacture. As energy costs increase, and if carbon taxes are enacted, the cost of manufacturing wallboard from calcined gypsum will continue to go up directly with the cost of energy. Moreover, material producers carry the responsibility to find less-energy dependent alternatives for widely used products as part of a global initiative to combat climate change.

The use of energy in the manufacture of gypsum wallboard has been estimated to approach 1% of all energy usage (in BTU's) in the US. With 40 to 50 billion square feet of wallboard used each year in the US, up to 900 trillion BTU's may be consumed in the manufacture of same. And as such, more than 50 million tons of greenhouse gasses are released into the atmosphere through the burning of fossil fuels to support the heat intensive processes, thus harming the environment and contributing to global warming.

Prior art focuses on reducing the weight of gypsum board or increasing its strength, or making minor reductions in energy use. For example in U.S. Pat. No. 6,699,426, a method is described which uses additives in gypsum board to reduce the drying time and thus reduce energy usage at the drying stage. These attempts generally start assuming the use of calcined gypsum (either natural or synthetic), since gypsum wallboard manufacturers would find that redesigning the materials and mining procedures from scratch would potentially throw away billions of dollars of infrastructure and know-how, and render their gypsum mines worthless.

However, given concerns about climate change, it would be desirable to manufacture wallboard which requires dramatically less energy usage during manufacture including elimination of calcining, hot water, and drying steps common to gypsum wallboard manufacturing.

### SUMMARY OF INVENTION

In accordance with the present invention, new methods of manufacturing novel wallboards (defined herein as “EcoRock™” wallboards), are provided. The resulting novel EcoRock wallboards can replace gypsum wallboard in most applications. Wallboards formulated in such a way significantly reduce the Embodied Energy associated with the wallboards, thus substantially reducing greenhouse gas emissions that harm the environment.

This invention will be fully understood in light of the following detailed description taken together with the drawings.

### DRAWINGS

FIG. 1 shows certain standard gypsum drywall manufacturing steps, specifically those which consume substantial amounts of energy.

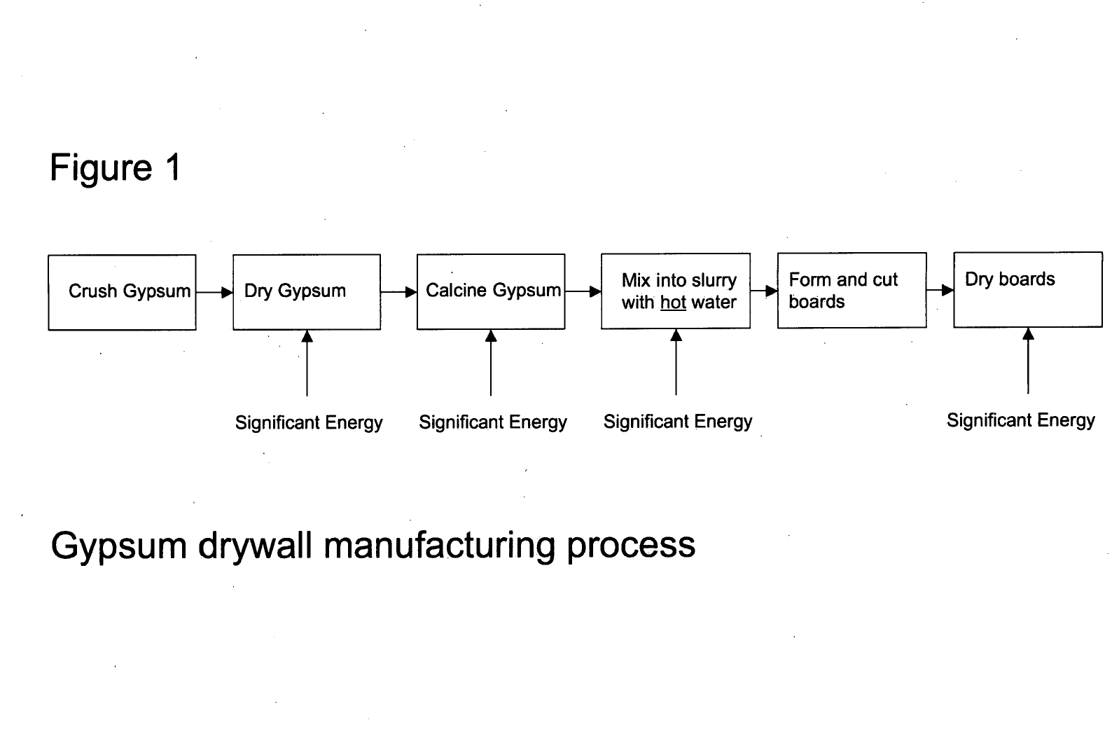

FIG. 2 shows the EcoRock manufacturing steps which as shown require little energy.

### DETAILED DESCRIPTION

The following detailed description of embodiments of the invention is illustrative only and not limiting. Other embodiments will be obvious to those skilled in the art in view of this description. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. Various changes in the details may be made without departing from the spirit, or sacrificing any of the advantages of the present invention. The detailed descriptions below are designed to make such embodiments obvious to a person of ordinary skill in the art.

The novel processes as described herein for manufacturing wallboard eliminate the most energy intensive prior art processes in the manufacture of gypsum wallboard such as gypsum drying, calcining, hot water, and board drying. The new processes allow wallboard to be formed from non-calcined materials which are plentiful and safe and which can react naturally to form a strong board that is also fire resistant.

The new EcoRock wallboard contains a binder of one or more of magnesium oxide (MgO,) calcium oxide, calcium hydroxide, iron oxide (Hematite or Magnetite) and a solution of alkali phosphate salt (sodium phosphate, potassium phosphate, monopotassium phosphate, tripotassium phosphate, triple super phosphate, calicium dihydrogen phosphate, dipotassium phosphate or phosphoric acid). The selected binder materials, often together with fillers, are mixed together at the start of the particular EcoRock manufacturing process or processes selected to be used to form the EcoRock wallboard or wallboards. Prior to the addition of liquids, such as water, this mix of binder and filler powders is called the “Dry Mix.” The MgO may be calcined or uncalcined. However uncalcined MgO may be less expensive and provide significant energy savings over calcined MgO. Thus there is no need to use calcined MgO, even though calcined MgO can be used in the EcoRock processes.

In US patent application 20060048682 Arun S. Wagh et al describe a sealant which can be applied (such as sprayed) in oil wells based on fly ash which, in part, uses MgO and KH₂PO₄ . This sealant is used to coat over existing cement in oil wells and is very hard. While there are some binder ingredients in the Wagh sealant similar to the binder ingredients used in the EcoRock wallboard, a wallboard for use in building construction is not described nor contemplated by Wagh. Nor does Wagh describe any embodiment with properties which would be characteristic of wallboards (such as score and snap ability).

Monopotassium phosphate is a soluble salt which is used as a fertilizer, a food additive and a fungicide. Magnesium oxide, the eighth most abundant element in the earth's crust, is a white solid mineral that occurs naturally from magnesite, dolomite or seawater and is used in waste management applications. These ingredients may be combined in many different ratios to each other, resulting in various set times and strengths.

A process in accordance with this invention based on monopotassium dihydrogen phosphate (KH2PO4) will now be described. After the addition of water (H₂O) and magnesium oxide (MgO) the reaction product is magnesium potassium phosphate (MgKPO₄.6H₂O) that is formed by dissolution of MgO in the solution of KH₂PO₄ and its eventual reaction to form a solidified product. This reaction product is referred to as “binder” hereinafter.

While cement boards have been described in the prior art using both Portland cement and using, in part, calcined magnesia (such as in U.S. Pat. No. 4,003,752), these boards have several issues in comparison to standard gypsum wallboard including weight, processing and score/snap capability. They do not describe an exothermic reaction with certain phosphates which creates the binder in this invention.

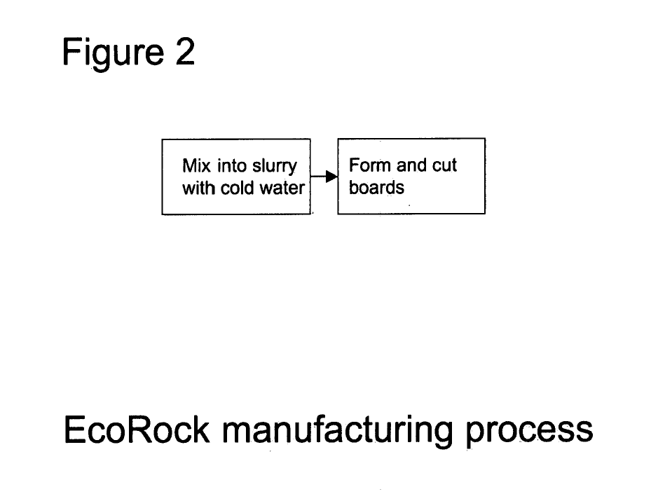

In the processes of this invention, an exothermic reaction between the binder components naturally starts and heats the slurry. The reaction time can be controlled by many factors including overall composition of slurry, percent (%) binder by weight in the slurry, the fillers in the slurry, the amount of water or other liquids in the slurry and the addition of boric acid to the slurry. Boric acid (powder form) slows down the reaction. Alternate retardants can include borax, sodium tripolyphosphate, sodium sulfonate, citric acid and many other commercial retardants common to the industry. FIG. 2 shows the simplicity of the process of this invention in that FIG. 2 shows two steps: namely mixing the slurry with cold water (thus saving significant energy) and then forming the wallboards from the slurry. The wallboards can either be formed in molds or formed using a conveyor system of the type used to form gypsum wallboards and then cut to the desired size.

The slurry starts thickening quickly, the exothermic reaction proceeds to heat the slurry and eventually the slurry sets into a hard mass. Typically maximum temperatures of 40° C. to 90° C. have been observed depending on filler content and size of mix. The hardness can also be controlled by fillers, and can vary from extremely hard and strong to soft (but dry) and easy to break. Set time, strong enough to remove the boards from molds or a continuous slurry, can be designed from 20 seconds to days, depending on the additives or fillers. For instance boric acid can extend the set time from seconds to days where powdered boric acid is added to the binder in a range of 0% to 3%. While a set time of twenty (20) seconds leads to extreme productivity, the slurry may begin to set too soon for high quality manufacturing, and thus the set time should be adjusted to a longer period of time typically by adding boric acid.

Many different configurations of materials are possible in accordance with this invention, resulting in improved strength, hardness, score/snap capability, paper adhesion, thermal resistance, weight and fire resistance. The binder is compatible with many different fillers including calcium carbonate (CaCO₃), wolastinite (calcium silicate,) cornstarch, ceramic microspheres, perlite, flyash, waste products and other low-embodied energy materials. Uncalcined gypsum may also be used as a filler. By carefully choosing low-energy, plentiful, biodegradable materials as fillers, such as those listed above, the wallboard begins to take on the characteristics of gypsum wallboard. These characteristics (weight, structural strength so as to be able to be carried, the ability to be scored and then broken along the score line, the ability to resist fire, and the ability to be nailed or otherwise attached to other materials such as studs) are important to the marketplace and may be required to make the product a commercial success as a gypsum wallboard replacement.

Calcium carbonate (CaCO₃) is plentiful and non-toxic. Cornstarch, made from corn, is plentiful and non toxic. Ceramic microspheres are a waste product of coal-fired power plants, and can reduce the weight of materials as well as increase thermal and fire resistance of the wallboards that incorporate these materials. The dry mix can include up to 80% by weight of ceramic microspheres. Such a dry mix has been successfully incorporated in EcoRock. Higher concentrations increase cost and can reduce strength. Fly ash is also a waste product of coal-fired power plants which can be effectively reutilized here. The dry mix can include up to 80% by weight of fly ash. Such a dry mix has been successfully incorporated into EcoRock; however very high concentrations of fly ash can increase weight, darken the core color, and harden the core to an extent that may be undesirable. Biofibers (i.e. biodegradable plant-based fibers) are used for tensile and flexural strengthening in this embodiment; however other fibers, such as cellulose or glass, may also be used. The use of specialized fibers in cement boards is disclosed in U.S. Pat. No. 6,676,744 and is well known to those practicing the art.

### EXAMPLE 1

In one embodiment of the present invention, a Dry Mix of powders is created using the following materials by weight:

| | |
|---|---|
| Monopotassium phosphate | 27% |
| Magnesium oxide | 9% |
| Calcium carbonate | 18% |
| Cornstarch | 11% |
| Ceramic microspheres (500 um diameter) | 33% |
| Biofibers | 1% |
| Boric acid | 1% |

Monopotassium phosphate and magnesium oxide together form a binder in the slurry and thus in the to-be-formed core of the EcoRock wallboard. Calcium carbonate, cornstarch and ceramic microspheres form a filler in the slurry and the biofibers strengthen the core, when the slurry has hardened. Boric acid is a retardant to slow the exothermic reaction and thus slow down the setting of the slurry.

Water, equivalent to 34% of the Dry Mix by weight, is then added to the Dry Mix to form a slurry. The wet mix (the “Initial Slurry”) is mixed by the mixer in one embodiment for three (3) minutes. Mixers of many varieties may be used, such as a pin mixer, provided the mix can be quickly removed from the mixer prior to hardening.

The slurry may be poured onto a paper facing, which can be wrapped around the sides as in a standard gypsum process. Neither backing paper nor paper adhesives are required with this embodiment, but can be added if desired.

An exothermic reaction will begin almost immediately after removal from the mixer and continue for several hours, absorbing most of the water into the reaction. Boards can be cut and removed in less than 30 minutes, depending on handling equipment available. All of the water has not yet been used in the reaction, and some absorption of the water will continue for many hours. Within 24-48 hours, the majority of water has been absorbed, with some evaporation occurring as well. When paper facing is used, it is recommended that the boards be left to individually dry for 24 hours so as to reduce the possibility of mold forming on the paper. This can be accomplished on racks at room temperature with no heat required. Drying time will be faster at higher temperatures and slower at lower temperatures above freezing. Temperatures above 80 F were tested but not considered since the design targets a low energy process. Residual drying will continue to increase at higher temperatures, however it is not beneficial to apply heat (above room temperature) due to the need of the exothermic reaction to utilize the water that would thus be evaporated too quickly. While the exothermic reaction will occur below freezing, the residual water will be frozen within the core until the temperature rises above freezing. It is presumed that ambient humidity levels will affect residual dry time as well, though this has not been investigated.

The resulting boards (the “Finished Product”) have strength characteristics similar or greater than the strength characteristics of gypsum wall boards, and can be easily scored and snapped in the field. This binder creates the unique ability to lightly (or strongly) bond certain fillers (as compared to Portland cement, commonly used for cement boards). Cement boards (which are often used for tile backing and exterior applications) do not exhibit many of the appealing aspects of gypsum boards for internal use such as low weight, score and snap, and paper facing.

### EXAMPLE 2

In another embodiment, the same amounts of dry powders as in Example 1 are mixed together in the same proportions, but the boric acid is left out. In this case, the reaction occurs much more rapidly such that the boards may be cut and removed in under 5 minutes

### EXAMPLE 3

In another embodiment, the same amounts of dry powders as in Example 1 are mixed together in the same proportions, but the water added contains a foaming agent (typically a soap) added through a foam generator. This produces a board of slightly less strength and reduced weight. Examples of foaming used in gypsum wallboards include those described in U.S. Pat. No. 5,240,639, U.S. Pat. No. 5,158,612, U.S. Pat. No. 4,678,515, U.S. Pat. No. 4,618,380 and U.S. Pat. No. 4,156,615. The use of such agents is well known to those practicing the art of manufacturing gypsum wallboard.

### EXAMPLE 4

In another embodiment, a board is made for exterior use by increasing the weight of binders in the slurry and thus in the core of the to-be-formed wallboard. This gives to the resulting EcoRock wallboard additional strength and water resistance. In addition, in this embodiment, no paper facing or wrap is used because the wallboard will be exposed to the environment. The makeup by weight of this embodiment is as follows:

| | |
|---|---|
| Monopotassium phosphate | 41% |
| Magnesium oxide | 14% |
| Calcium carbonate | 25% |
| Cornstarch | 6% |
| Ceramic microspheres (500 um diameter) | 12% |
| Bio fibers | 1% |
| Boric Acid | 1% |

Water, equivalent to 32% of the Dry Mix by weight, is then added to the Dry Mix to form a slurry.

### END EXAMPLE 4

In other embodiments, the ratio of the binders monopotassium phosphate to magnesium oxide can be varied such that they are both equal amounts by weight. This can result in lower water usage. As a feature of this invention, the ratio of one binder component to the other binder component by weight can be varied to minimize the cost of materials. A combination of 10% of one binder ingredient to 90% of the other has been mixed demonstrating an acceptable exothermic reaction.

The processing of the slurry may occur using several different techniques depending on a number of factors such as quantity of boards required, manufacturing space and familiarity with the process by the current engineering staff. The normal gypsum slurry method using a conveyor system, which is a continuous long line that wraps the slurry in paper is one acceptable method for fabricating most embodiments of the EcoRock wallboards of this invention. This process is well known to those skilled in manufacturing gypsum wallboard. Also the Hatscheck method, which is used in cement board manufacturing, is acceptable to manufacture the wallboards of this invention, specifically those that do not require paper facing or backing, and is well known to those skilled in the art of cement board manufacturing. Additional water is required to thin the slurry when the Hatscheck method is used because the manufacturing equipment used often requires a lower viscosity slurry. Alternatively as another manufacturing method, the slurry may be poured into pre-sized molds and allowed to set. Each board can then be removed from the mold, which can be reused.

Other embodiments of this invention will be obvious in view of the above disclosure.

What is claimed is:

1. A binder for a wallboard, said binder comprising:
one or more of magnesium oxide (MgO,) calcium oxide, calcium hydroxide and iron oxide (hematite or magnetite); and
at least one alkali phosphate salt.

2. The binder of claim 1 wherein said at least one alkali phosphate salt comprises one or more of the following compounds: sodium phosphate, potassium phosphate, monopotassium phosphate, tripotassium phosphate, triple super phosphate or dipotassium phosphate.

3. A wallboard using the binder of claim 1 where the binder comprises ≦80% of the overall weight of the wallboard.

4. A wallboard using the binder of claim 1 where the binder comprises ≦50% of the overall makeup of the wallboard.

5. A wallboard using the binder of claim 1 where the binder comprises ≦20% of the overall makeup of the wallboard.

6. A wallboard using the binder of claim 1 where the binder comprises ≦10% of the overall makeup of the wallboard.

7. A wallboard using the binder of claim 1 where the binder comprises ≦5% of the overall makeup of the wallboard.

8. A wallboard using the binder of claim 1, wherein the wallboard further comprises fibers selected from the group consisting of biofibers, nylon, glass and cellulose.

9. A wallboard using the binder of claim 1 further comprising a filler selected from the group consisting of calcium carbonate, perlite and calcium sulfate dihydrate.

10. A wallboard using the binder of claim 1, said wallboard further comprising a filler of ceramic microspheres.

11. A wallboard using the binder of claim 1, said wallboard further comprising corn starch.

12. A wallboard using the binder of claim 1, said wallboard further comprising tapioca starch.

13. A wallboard using the binder of claim 1, said wallboard further comprising a filler of flyash.

14. A wallboard with a size of at least 16 square feet with an outer layer of paper on at least 1 side, comprising:
a binder of one or more of magnesium oxide (MgO,) calcium oxide, calcium hydroxide, iron oxide (Hematite or Magnetite);
one or more alkali phosphate salts selected from the group consisting of sodium phosphate, potassium phosphate, monopotassium phosphate, tripotassium phosphate, triple super phosphate or dipotassium phosphate; and
water less than or equal to approximately 50% by weight of the wallboard.

15. The wallboard of claim 14 where the binder comprises ≦80% of the overall makeup of the wallboard.

16. The wallboard of claim 14 where the binder comprises ≦50% of the overall makeup of the wallboard.

17. The wallboard of claim 14 where the binder comprises ≦20% of the overall makeup of the wallboard.

18. The wallboard of claim 14 where the binder comprises ≦10% of the overall makeup of the wallboard.

19. The wallboard of claim 14 where the binder comprises ≦5% of the overall makeup of the wallboard.

20. The wallboard of claim 14 further comprising fibers selected from the group consisting of biofibers, nylon, glass and cellulose.

21. The wallboard of claim 14 further comprising a filler of calcium carbonate and/or perlite.

22. The wallboard of claim 14 further comprising a filler of ceramic microspheres.

23. The wallboard of claim 14 further comprising corn starch.

24. The wallboard of claim 14 further comprising tapioca starch.

25. The wallboard of claim 14 further comprising a filler of flyash.

26. A wallboard with a size of at least 16 square feet, with an average thickness between 0.1″ and 1.0″, comprising:
a binder of one or more of magnesium oxide (MgO,) calcium oxide, calcium hydroxide, iron oxide (hematite or magnetite);
one or more alkali phosphate salts selected from the group consisting of sodium phosphate, potassium phosphate, monopotassium phosphate, tripotassium phosphate, triple super phosphate or dipotassium phosphate);
water equal to or less than approximately 50% by weight of the wallboard; and;
an outer layer of paper on at least one (1) side of the wallboard.

27. The wallboard of claim 26 where the binder comprises ≦80% of the overall makeup of the product.

28. The wallboard of claim 26 where the binder comprises ≦50% of the overall makeup of the wallboard.

29. The wallboard of claim 26 where the binder comprises ≦20% of the overall makeup of the wallboard.

30. The wallboard of claim 26 where the binder comprises ≦10% of the overall makeup of the wallboard.

31. The wallboard of claim 26 where the binder comprises ≦5% of the overall makeup of the wallboard.

32. The wallboard of claim 26, further comprising fibers selected from the group consisting of biofibers, nylon, glass and cellulose.

33. The wallboard of claim 26 further comprising a filler of calcium carbonate and/or perlite.

34. The wallboard of claim 26 further comprising a filler of ceramic microspheres.

35. The wallboard of claim 26 further comprising corn starch.

36. The wallboard of claim 26 further comprising tapioca starch.

37. The wallboard of claim 26 further comprising a filler of flyash.

38. A wallboard with a size of at least 16 square feet, with an average thickness between 0.1″ and 1.0″, comprising:
a binder comprising one or more of magnesium oxide (MgO,) calcium oxide, calcium hydroxide, iron oxide (hematite or magnetite);
alkali phosphate salt or salts selected from the group consisting of sodium phosphate, potassium phosphate, monopotassium phosphate, tripotassium phosphate, triple super phosphate or dipotassium phosphate;
water less than 50% by weight of the initial slurry; and
an outer layer of fiberglass matt on at least one (1) side.

39. The wallboard of claim 38 where the binder is ≦80% of the overall makeup of the wallboard.

40. The wallboard of claim 38 where the binder comprises ≦50% of the overall makeup of the wallboard.

41. The wallboard of claim 38 where the binder comprises ≦20% of the overall makeup of the wallboard.

42. The wallboard of claim 38 where the binder comprises ≦10% of the overall makeup of the wallboard.

43. The wallboard of claim 38 where the binder comprises ≦05% of the overall makeup of the wallboard.

44. The wallboard of claim 38 further comprising fibers selected from the group consisting of biofibers, nylon, glass, cellulose.

45. The wallboard of claim 38 further comprising a filler of calcium carbonate and/or perlite.

46. The wallboard of claim 38 further comprising a filler of ceramic microspheres.

47. The wallboard of claim 38 further comprising corn starch.

48. The wallboard of claim 38 further comprising tapioca starch.

49. The wallboard of claim 38, further comprising a filler of flyash.

50. A wallboard with a size of at least 16 square feet, with an average thickness between 0.1″ and 1.0″ comprising:
a binder of one or more of magnesium oxide (MgO,) calcium oxide, calcium hydroxide, iron oxide (hematite or magnetite);
an alkali phosphate salt;
a filler of calcium carbonate where said calcium carbonate makes up greater than 30% of the weight of the wallboard, and;
an outer layer of paper on at least one (1) side.

51. The wallboard of claim 50 wherein said alkali phosphate salt comprises one or more salts selected from the group of salts consisting of sodium phosphate, potassium phosphate, monopotassium phosphate, tripotassium phosphate, triple super phosphate or dipotassium phosphate.

52. The wallboard of claim 50 wherein the binder comprises ≦80% of the overall makeup of the wallboard.

53. The wallboard of claim 50 wherein the binder comprises ≦50% of the overall makeup of the wallboard.

54. The wallboard of claim 50 wherein the binder comprises ≦20% of the overall makeup of the wallboard.

55. The wallboard of claim 50 wherein the binder comprises ≦10% of the overall makeup of the wallboard.

56. The wallboard of claim 50 wherein the binder comprises ≦5% of the overall makeup of the wallboard.

57. The wallboard of claim 50 further comprising fibers selected from the group consisting of biofibers, nylon, glass, cellulose.

58. The wallboard of claim 50 further comprising a filler of ceramic microspheres.

59. The wallboard of claim 50 further comprising corn starch.

60. The wallboard of claim 50 further comprising tapioca starch.

61. The wallboard of claim 50 further comprising a filler of flyash.

62. A method of fabricating a wallboard, comprising:
forming a slurry comprising:
a binder comprising one or more of magnesium oxide (MgO,) calcium oxide, calcium hydroxide and iron oxide (hematite or magnetite); and
at least one alkali phosphate salt; and
allowing the slurry to set.

63. The method of claim 62 further comprising cutting the set slurry to a desired shape.

64. The method of claim 62 including:
adding a material to the slurry to increase the time taken for the slurry to set.

65. The method of claim 64 wherein the material added to the slurry is boric acid.

66. The method of claim 62 wherein the at least one phosphate salt comprises one or more of the following compounds: sodium phosphate, potassium phosphate, monopotassium phosphate, tripotassium phosphate, triple super phosphate or dipotassium phosphate.
